(19) United States
(12) Patent Application Publication
(10) Pub. No.: US 2019/0375477 A1
(43) Pub. Date: Dec. 12, 2019

(54) STRUCTURAL ELEMENT

(71) Applicant: I.G. CARDBOARD TECHNOLOGIES LTD., Tel Aviv (IL)

(72) Inventor: Izhar GAFNI, Ahituv (IL)

(21) Appl. No.: 16/463,156

(22) PCT Filed: Nov. 21, 2017
(86) PCT No.: PCT/IL2017/051274

§ 371 Date: May 22, 2019

(30) Foreign Application Priority Data
Nov. 22, 2016 (IL) 249124
Aug. 2, 2017 (IL) 253787
Oct. 2, 2017 (IL) 254841

(51) Int. Cl. B62K 19/14; B32B 21/06; B32B 29/00; B32B 29/08; B32B 3/04; B32B 3/06; B32B 3/08; B32B 3/12; B32B 7/02; A61G 5/10

(52) U.S. Cl. CPC B62K 19/14; B65D 2585/6862; B32B 29/005; B32B 29/08; B32B 3/04; B32B 3/06; B32B 3/08; B32B 3/12; B32B 7/02; A61G 5/10; B32B 2307/3065; B32B 2307/7265; B32B 2307/584; B32B 2605/00; B65D 2581/02; B32B 21/06

(57) ABSTRACT

Some embodiments are directed to a structural element having a planar portion and at least one integral, formed edge portion. The structural element includes at least one elongated member and a formed 3-layered cardboard panel. The formed 3-layered cardboard panel includes a first and second external high density cardboard (HDC) sheet sandwiching a low density cardboard (LDC) layer between them, at least one edge-forming segment absent the second HDC sheet and the LDC layer, and planar segments flanking the edge-forming segments. An inner face of the first HDC sheet of the of the edge-forming segment is folded over and tightly associated to an external surface of the elongated member such as to envelope a top portion thereof to thereby define the formed edge portion. The planar segments is fixed to one another to define the planar portion.

### CROSS REFERENCE TO RELATED APPLICATIONS

This application is a national phase filing under 35 C.F.R. § 371 of and claims priority to PCT Patent Application No. PCT/IL2017/051274, filed on Nov. 21, 2017, which claims the priority benefit under 35 U.S.C. § 119 Israeli Patent Application Nos. 249124 filed on Nov. 22, 2016, 253787 filed on Aug. 2, 2017, and 254841 filed on Oct. 2, 2017, the contents of each of which are hereby incorporated in their entireties by reference.

### FIELD

The presently disclosed subject matter concerns a structural element including cardboard as a main constituent. A structural element of this disclosure may be planar or an elongated element that can be used as board, strut, beam, frame element, etc.

### BACKGROUND

Structural elements made of cardboard as the primary constituent are known (see PCT Publications WO 2014/061012 and WO 2014/141228). In particular, WO 2014/061012 provides structural elements including an elongated internal member and an elongated external member enclosing the internal member. The internal member is a rounded rod which may be made of cardboard or another material; and the external member may be constructed of a cardboard sheet that is folded about a mid-portion thereof, so as to envelope the internal member, to form a tight association with the internal member's external surface. The two members jointly define a first core-envelope sub-structure; while the portions of the sheet that flank the mid portion jointly define a second layered sub-structure. This structural element has a load-bearing capacity significantly larger than each of the individual members.

### SUMMARY

Provided by this disclosure is a structural element with cardboard as its main constituent. Having cardboard as its main constituent, means that it includes at least 80%, at times 85%, 90% and even 95% on a weight/weight basis of cardboard; and at times even includes almost 100% cardboard. The remaining, non-cardboard materials include adhesives which adhere the members to one another (as will be specified below) and may include an external coating, lacquer, varnish, paint, etc. The structural element of this disclosure has a planar portion extending from a formed edge portion. By one embodiment (referred to herein as the “one-edge embodiment”) the structural element has one such formed edge portion and by another embodiment (the “two-edge embodiment”) there are two such edge portions, parallel to one another with the planar portion extending therebetween. The edge portion is formed by associating and folding of at least one segment of a cardboard panel (referred to herein as the “edge forming segment”) over an elongated member, which may have a polygonal or (typically, but not exclusively) a rounded cross-section, and the planar portion is constituted by segments of the panel that are associated with one another to form a multi-layer planar structure as defined and described below (each of these segments will be referred to herein as “planar segment”).

The overall cross-sectional shape of the formed edge may be generally that of the elongated member. By some embodiments, a shape-modifying auxiliary edge member may be fitted over the formed edge to modify its cross-section, e.g. from rounded to polygonal, in particular into a right-angled shape; namely, into an edge having a surface that is normal to the element's plane.

The elongated member (to be defined below), while possibly made of cardboard, by some embodiments may also be made of other materials, for example, plastic (particularly recycled plastic) or wood.

The elongated member extends along an axis and has, typically, a rounded (for example, circular) cross-section. The cardboard panel has 3 layers which includes first and second external high density cardboard sheets that sandwich between them a low density cardboard layer.

The term “high density cardboard (or HDC) sheet” refers to a cardboard sheet, that is relatively (as compared to non-HDC cardboard panels) solid and uniform, without voids visible to the naked eye and is typically compressed. It may have an aerial specific weight in the range of at least 200 grams per square meter (g/m²); typically in the range of 400-700 g/m². A particular example is heavy duty cardboard that has density in the range of 400-600 g/m². The HDC sheet used in this disclosure may have a thickness in the range of 0.5-3 mm, typically 1-1.5 mm An HDC sheet, when held tightly in a planar configuration to avoid it from bending, as in the structural element of this disclosure, as also illustrated below, displays a compression resistance in a direction parallel to its plane.

The term “low density cardboard (or LDC) layer” refers to a cardboard layer with an internal structure with a plurality of cells or voids; for example, formed by corrugated, fluted or otherwise loosely packed paper sheets or strips. Examples of the cardboard panels that comprise a low density cardboard layer are such known as “corrugated cardboard” or “honeycombed cardboard” which can consist of fluted or corrugated paper mass sandwiched between two flat liner boards, e.g. made of HDC.

The edge-forming segment of the panel is defined between two planar segments and is absent the second HDC sheet and the LDC layer; for example having been cut out, or otherwise removed. The inner face of the first HDC sheet is folded over and tightly associated (e.g. by adhesion) to the external surface of the first member, so as to envelope the top portion thereof. Upon such folding, the two planar segments become associated with one another through attachment of their respective second HDC sheet, e.g. by adhesion; this defining the planar portion of the structural element.

The planar portion is typically formed to extend the length of the elongated member.

Typically, but not exclusively, the maximal horizontal cross-sectional dimension of the elongated member is approximately (namely within the range of plus or minus 10%) equal to twice the thickness of the 3-layered cardboard panel.

Once the planar segments are attached to one another, their respective second HDC sheets form together a joint high density structure at about the mid-plane of the planar portion. The high density structure is sandwiched between the other layers of the planar segments that together provide for bend resistance. This bend resistance functions to keep the high density structure in a planar configuration in which it imparts a compression resistance along the plane of the structural element.

By one embodiment of this disclosure, the high density structure is constituted by the associated high density layers of the planar segments. By another embodiment, one or more third high density sheets are fitted between the juxtaposed second high density layers.

By an embodiment of this disclosure, the constituents of the high density structure are adhered to one another by an adhesive. By another embodiment, these are held together by a compression force applied by a reinforcing end element that clamps the two flanking segments one against the other, in addition to or instead of the use of an adhesive. An example of such a reinforcing end element, applicable for the one-edge embodiment, is an end element made of high density cardboard (which may be one-, two- or multiple-layered) that is formed into a right angled trough fitted over ends of the planar segments that thereby (i) clamp them together, (ii) seal the ends and providing added force to hold the two planar segments together, (iii) provide for a straight and even end of the structural element, and (iv) provide extra rigidity to the structural element. Another example are rivets fitted into the planar segment in addition of instead of the adhesive.

The structural element of the two-edge embodiment is generally symmetrical about a midline, parallel and in between the two edges. This dual edges structure adds functionality and rigidity to the structural element.

By one embodiment, the elongated member is made of a solid mass, e.g. cardboard. By another embodiment, the elongated member is formed with an axial lumen. A particular example of the elongated member is one that is cylindrical, typically tubular. As noted above, the elongated member is typically made of cardboard.

The structural element of this disclosure has a load-bearing or bend-resistance property significantly larger than that of the elongated member alone; or that of a two-layered structure made from the cardboard panel; or that of a two-layered structure made from the cardboard panel with one or more additional high density cardboard layers disposed between the opposite first high density layers; or that formed with a reinforcing bottom element. The higher load-bearing or bend-resistance of the structural element is at least 2, 3, 4, 5, 6, 7, 8, 9 and even 10 folds larger as compared to any of its constituents alone (namely the elongated member or the planar portion without the edge portion).

As can be appreciated, the structural element of this disclosure has typically a longitudinal plane of symmetry passing between the planar segments.

As can also be appreciated and as it appears from the above, the structural element of this disclosure may be coated by a variety of coatings, such which impart fire resistance, water resistance, and others. This may be achieved by a variety of paints, lacquers, etc.

The structural element of this disclosure may be incorporated in a variety of structures and frames. By one embodiment it is an a generally axially elongated element that may be used as a beam, strut or another frame component. By another embodiment, the planar portion may define an overall board-like configuration.

The disclosure also provides a device including one or more structural elements of this disclosure. A particular use of the structural element is as part of a frame, for example, the frame of a vehicle, e.g. bicycle or wheelchair. Other examples are structural elements such as struts, beams, panels, shelves, frames for buildings, ceiling or wall-supporting frames, vehicle's frames, etc.

Another aspect of this disclosure concerns a structural unit that includes two or more elements of this disclosure. By one embodiment, an edge of a first of the two or more elements forms an association edge and is associated with the planar portion of a second of the two or more elements; e.g. forming a T-beam. A structural unit of this aspect may comprise one or more of the first structural elements and one or more of the second structural elements. In some embodiments, a first of the two or more structural elements is associated with planar portions of two second of the two or more structural elements, whereby both of edges of the first structural element constitute association edges. The structural unit of this later embodiment may be used as an I-beam as an engineering element, e.g. in construction.

The association edge may be defined by an edge surface, e.g. one that is normal to the plane of the first element. The association edge may be defined, by one embodiment, by a shape-modifying auxiliary member. The first and the second structural elements are typically associated with one another, e.g. adhered, such that they are normally oriented to one another.

### BRIEF DESCRIPTION OF THE DRAWINGS

In order to better understand the subject matter that is disclosed herein and to exemplify how it may be carried out in practice, embodiments will now be described, by way of non-limiting example only, with reference to the accompanying drawings, in which:

FIG. 1A is a schematic isometric view of a structural element according to an exemplary one-edge embodiment of this disclosure.

FIG. 1B is a cross-section taken along the line I-I in FIG. 1A.

FIGS. 2A and 2B are schematic cross-sections of two other exemplary one-edge embodiments of this disclosure.

FIGS. 3A-3C exemplify schematically the manner of constructing the structural element of FIGS. 1A-1B showing three consecutive steps in the manufacturing process.

FIG. 4 is a side perspective view of an exemplary two-edge embodiment of this disclosure.

FIGS. 5A-5C exemplify schematically the manner of constructing the structural element of FIG. 4 showing three consecutive steps in the manufacturing process.

FIG. 6 schematically exemplifies a T-beam according to an embodiment of this disclosure.

FIG. 7 schematically exemplifies an I-beam according to an embodiment of this disclosure.

### DETAILED DESCRIPTION OF EXEMPLARY EMBODIMENTS

The annexed drawings show schematic representations illustrating exemplary and non-limiting embodiments of this disclosure. The illustrated embodiments are of a structural element according to the presently disclosed subject matter.

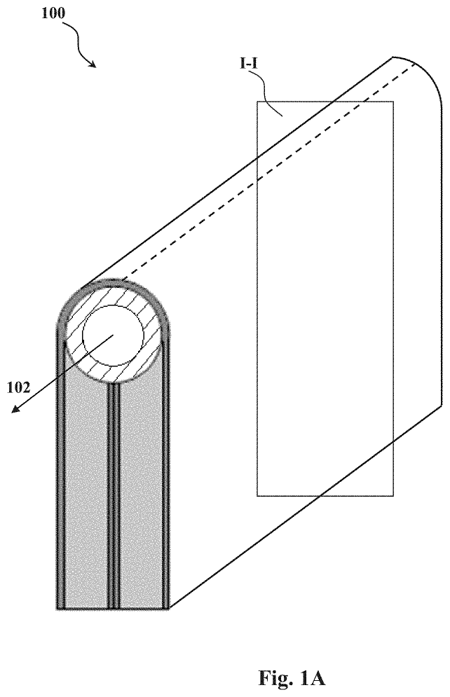

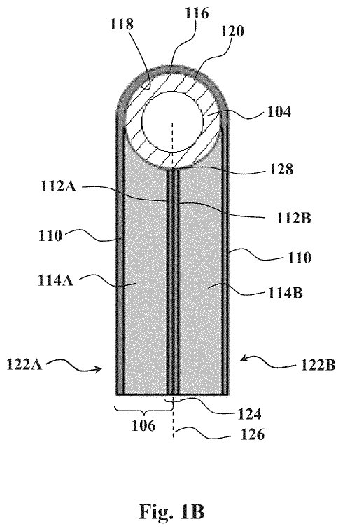

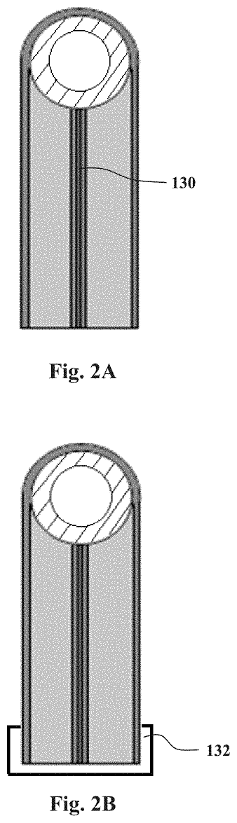

Elongated structural element 100, being an element according to the one-edge embodiment, is shown in FIGS. 1A and 1B. Element 100 extend along axis 102 and is constituted by two cardboard constituents, including a tubular member 104 and a 3-layered cardboard panel 106. The term “constitute” (or any lingual variation thereof) should be understood as meaning that these are the main structural constituents. Another constituent is adhesive which is used to adhere the main structural components to one another. Other elements may include reinforcing pins that traverse the two opposite faces of the element or an additional reinforcing bottom element, which is illustrated below in FIG. 2B.

The cardboard panel 106 has first and second high density cardboard (HDC) sheets 110, 112 that sandwich a low density cardboard (LDC) layer 114 between them. The cardboard panel 106 has edge-forming segment 116 with just the first HDC layer; the edge-forming segment is absent the second HDC sheet and the LDC layer. For example, for forming the edge-forming segment 116, respective portions of the second HDC sheet and the LDC layer are cut out of the panel 106, thereby exposing the internal face 118 of the first HDC sheet at the segment. The internal face 118 of the edge-forming segment 116 is tightly associated to (e.g. by adhering) an external face 120 of first member 104.

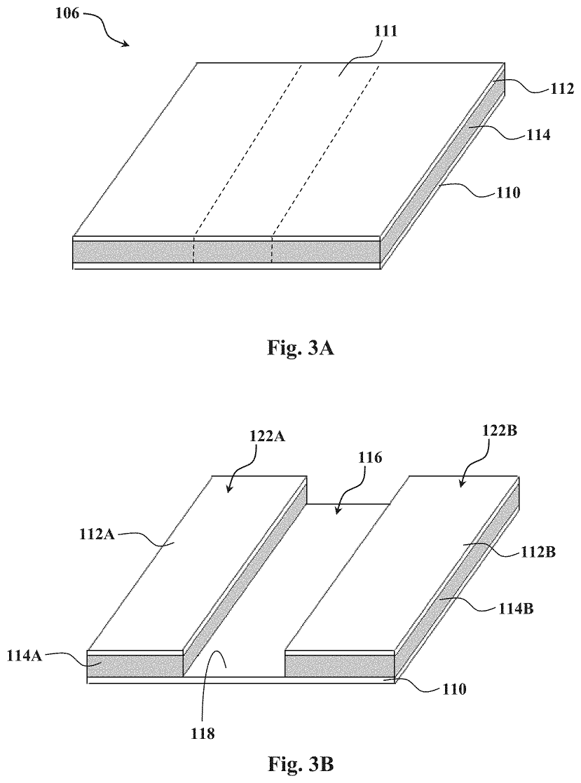

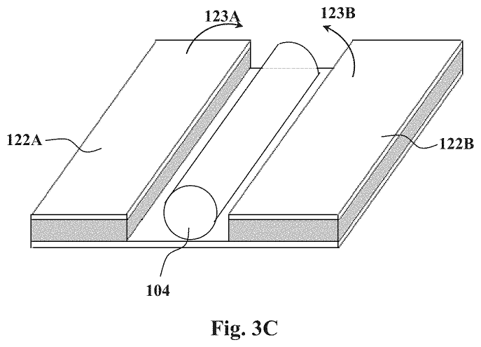

The edge-forming segment 116 (better seen in FIG. 3B) defines two flanking planar portions 122A, 122B that are mirror images one of the other, and in the structural element seen in FIG. 1B, define together a multi-layered planar portion that extends (downwards in the orientation in the drawing) from the elongated member 104. In this multi-layered planar portion, the two respective HDC sheet portions 112A, 112B form together a two-layer high density structure 124. As can be seen, this high density structure may be supplemented with at least one third, HDC sheet, as illustrated in FIG. 2A. The high density structure 124 is thus formed along a midline 126 of the structural element 100 with one side thereof being a mirror image of the other.

As can be seen in FIG. 1A (and also in FIGS. 2A-2B), the edge-forming segment is dimensioned such that, once combined with the elongated member to constitute the structural element, the high density structure 124 being in contact and hence supports a bottom portion 128 of the elongated member.

FIG. 2A is a cross-section of a structural element of this disclosure which is similar to that shown in FIG. 1A but with the addition of a third HDC sheet 130 between respective second HDC sheets 112A and 112B. As can be appreciated, in some embodiments, more than one third HDC sheet may be added between sheets 112A and 112B.

FIG. 2B illustrates an embodiment, similar to that of FIG. 1A, having the addition of reinforcing end element 132 which is constituted out of HDC sheet formed into a right-angled trough-like shape that embraces the bottom portions of the two planar segments. End element 132 thus functions to (i) hold the planar segments 122A and 122B tightly one against the other, (ii) seal the bottom end of the planar segments (and hence the bottom end of the structural element), (iii) provides for a flat and even bottom surface of the structural element, and/or (iv) adds structural rigidity to the element. While, as shown, end element 132 is made of a single sheet of HDC, it may have two or a plurality of HDC sheets fixed together to form end element 132.

Reference is now being made to FIGS. 3A-3C illustrating the manner of forming the structural element of FIG. 1A. Provided is a cardboard panel 106, illustrated schematically in FIG. 3A, constituted by respective first and second HDC sheets 110, 112 that sandwich an LDC layer 114 between them. From a portion thereof 111, which is the mid-portion in this exemplary embodiment, a portion of the second HDC sheet and a respective portion of the LDC layer are removed to thereby define an edge-forming segment 116 with an exposed inner face 118 of the first HDC sheet 110. By forming the edge-forming segment 116, the two flanking, planar segments 122A, 122B are also defined. An elongated tubular member 104 is then placed lengthwise at about a midline of the edge-forming segment 116, and the two planar segments 122A, 122B are folded about the elongated member 104 in directions represented by arrows 123A, 123B, to bring the respective second HDC sheets 112A, 112B of the planar segments into contact with one another, thus forming the structural element 100, as illustrated in FIGS. 1A-1B. Prior to association of first member 104 with the inner face 118 of central segment 116 and prior to folding, an adhesive may be applied. It should be noted that in other embodiments rather than removal of portion 111, the panel may be prepared a priori to have an edge-forming segment 116.

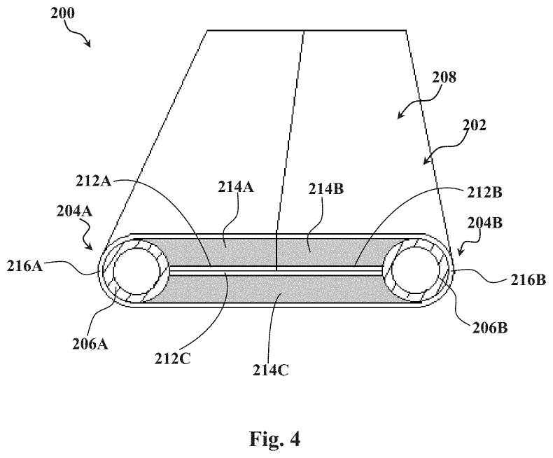

Reference is now being made to FIG. 4 showing an exemplary two-edged structural element 200 of this disclosure. Element 200 has a planar portion 202 defined between two rounded edge portions 204. The element is constituted by two elongated cylindrical members 206A, 206B, parallel to one another, and a formed three-layered cardboard panel 208. Panel 208 is a three-layered panel with first and second HDC layers 210, 212, sandwiching an LDC layer 214. The edges of the element are formed by the elongated members 206A, 206B and the first HDC layer 210 tightly associated and enveloping the elongated members 206. Portions of the panel form together a planar portion 202 of structural element 200, defined between the two edge portions.

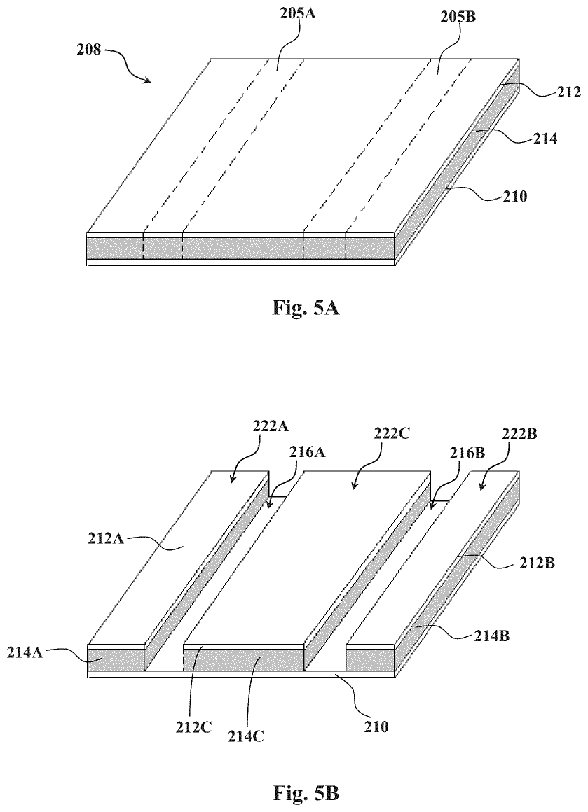

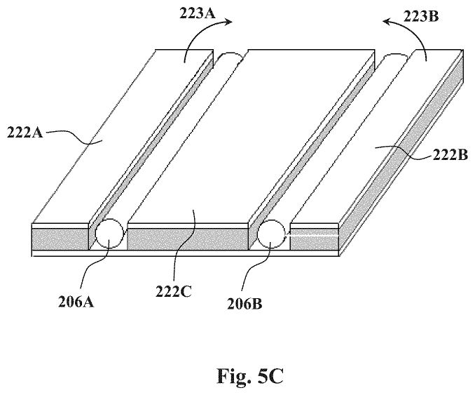

FIGS. 5A-5C illustrate schematically the manner of forming the structural element of FIG. 4. Some of the cardboard, including the HDC layer 212 and at least some of the LDC layer 214, typically all or most of it, from two segments 205A, 205B of cardboard panel 208 are removed to thereby define edge-forming segments 216A, 216B each flanked by two planar sections: segment 216A being flanked by segments 222A, 222C and segment 216B being flanked by segments 222B and 222C. The rounded elongated members 206A, 206B are then fitted into the edge-forming segments and then by folding the HDC sheet of the edge-forming segments over the elongated members 206A, 206B as represented by arrows 223A and 223B and then adhering opposite planar segments to one another, the structural element, as seen in FIG. 4, is formed. Segments 222A, 222B have a combined width, the same as that of segment 222C and consequently all or most of the planar segments form together a complete multi-layered cardboard structure constituting the planar portion of the element.

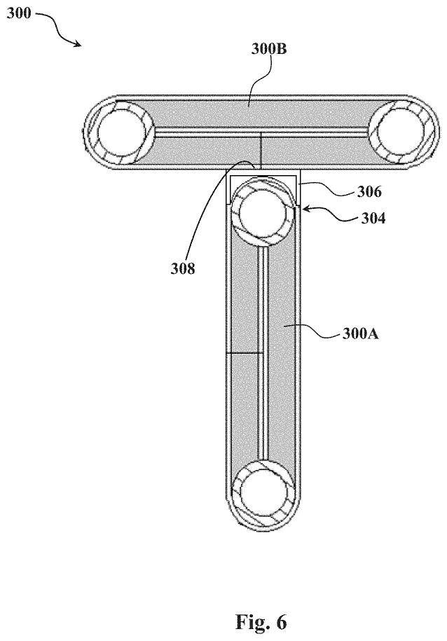

Reference is now being made to FIG. 6, showing a T-beam 300 in accordance with an embodiment of the disclosure. This T-beam is constructed of two planar elements: first structural element 300A and second structural element 300B having each a structure similar to that of element 200 shown in FIG. 4. Fitted on top of edge portion 304, is a shape-modifying auxiliary member 306, which has an overall shape of a rectangular trough, and fitting it over edge potion 304 modifies the overall cross-sectional shape of the edge to define an edge surface 308 that is normal to the plane defined by element 300A. This causes elements 300A and 300B to be normal one to the other.

For forming this association, the shape-modifying member 306 may first be fitted on top of edge 304, or member 306 may first be adhered on top element 300B and thereafter the edge 304 of element 300A may be fitted therein.

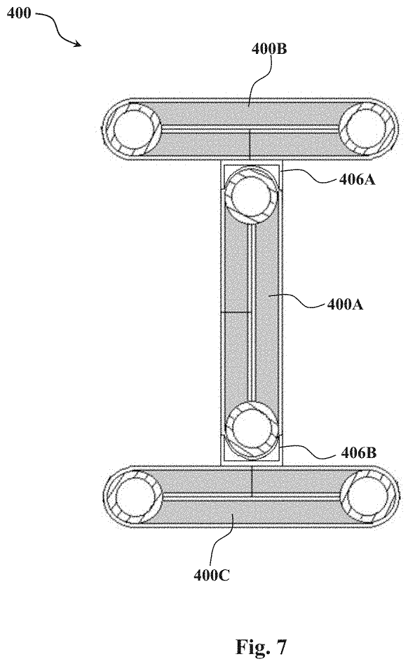

Reference is now being made to FIG. 7, which shows an I-beam 400 according to an embodiment of this disclosure. The I-beam 400 is constructed in a similar manner to that of T-beam 300 of FIG. 6, constructed out of three planar structural elements: one first structural element 400A, and two second structural elements 400B and 400C. element 400A is formed with two edge-modifying auxiliary members 406A, 406B, similar to element 306 on FIG. 6.

1. A structural element having a planar portion and at least one integral, formed edge portion, comprising:
at least one elongated member; and
a formed 3-layered cardboard panel including
a first and second external high density cardboard (HDC) sheet sandwiching a low density cardboard (LDC) layer between them,
at least one edge-forming segment absent the second HDC sheet and the LDC layer, and
planar segments flanking the edge-forming segments,
wherein
an inner face of the first HDC sheet of the at least one of the edge-forming segment is folded over and tightly associated to an external surface of the elongated member such as to envelope a top portion thereof to thereby define the formed edge portion, and
the planar segments being fixed to one another to define the planar portion.

2. The structural element of claim 1, wherein the respective second high density cardboard sheets of the two planar segments being adhered to one another to form a high density structure.

3. The structural element of claim 1, further comprising one or more third high density cardboard sheets fitted between the second high density cardboard sheets of the two planar segments.

4. The structural element of claim 1, having one formed edge portion.

5. The structural element of claim 4, further comprising a reinforcing end element made of high density cardboard formed to have a right-angled trough shape and fitted over the bottom portions of the two flanking segments.

6. The structural element of claim 1, wherein the formed edge is fitted with a shape-modifying auxiliary edge member.

7. The structural element of claim 1, having two formed edge portions with the planar portion extending therebetween.

8. The structural element of claim 7, wherein at least one of the formed edges is fitted with a shape-modifying auxiliary edge member.

9. (canceled)

10. The structural element of claim 1, wherein the first member is tubular.

11. (canceled)

12. A device comprising one or more structural elements according to claim 1.

13. The device of claim 12, further comprising a frame structure formed by the one or more structural elements.

14. The device of claim 12, being a wheeled vehicle selected from the group consisting of a bicycle and a wheelchair.

15. (canceled)

16. A structural unit comprising two or more elements of claim 1.

17. The structural unit of claim 16, wherein an association edge of a first of the two or more elements is associated with the planar portion of a second of the two or more elements.

18. The structural unit of claim 17, wherein the association edge is defined by an edge surface that is normal to the plane of the first element.

19. The structural unit of claim 18, wherein the association edge is defined by a shape-modifying auxiliary member.

20. The structural unit of claim 17, wherein the first element is normal to the second element.

21. The structural unit of claim 16, wherein two association edges of a first of the two or more elements are associated with the planar portion of two second of the two or more elements.

22. The structural unit of claim 21, wherein each of the association edges is defined by an edge surface that is normal to the plane of the first element and/or each of the association edges is defined by a shape-modifying auxiliary member.

23. (canceled)

24. The structural unit of claim 21, wherein (i) the first element is normal to the second elements and/or (ii) the structural unit is configured as an I-beam.

25. (canceled)
